(19) United States
(12) Patent Application Publication
(10) Pub. No.: US 2011/0154364 A1
(43) Pub. Date: Jun. 23, 2011

(54) SECURITY SYSTEM TO PROTECT SYSTEM SERVICES BASED ON USER DEFINED POLICIES

(75) Inventor: Murali Vaddagiri, Bangalore (IN)

(73) Assignee: INTERNATIONAL BUSINESS MACHINES CORPORATION, Armonk, NY (US)

(21) Appl. No.: 12/644,060

(22) Filed: Dec. 22, 2009

(51) Int. Cl. G06F 9/54

(52) U.S. Cl. 719/313; 719/328

(57) ABSTRACT

System Services to be protected, and corresponding user defined Policies are provided in a table. A module is provided in the operating system with instructions to intercept messages requesting use of System Services, correlate parameters from the messages with the table, and issue an error message signifying denial to a requesting entity if the parameters do not match an entry in the table. If the parameters match an entry in the table, the module generates, and issues a message, to the requesting entity, allowing access to the requested System Service. Optionally, the event may be logged in a memory, and the administrator is notified.

### BACKGROUND OF THE INVENTION

The present invention relates to computer security, in general, and in particular to security for protecting System Services.

Of all the gadgets that improve human productivity and quality of life the computer, if not the most important one, is probably at the top of the list. Computers are used in homes, businesses, organizations (civic and religious) etc. Communication over the World Wide Web (WWW), hereafter termed the internet, is one of the many functions provided by computers. The internet is an open communications highway that anyone can access from any part of the world. It is also possible for anyone to launch malicious codes to collect information to which they are not entitled or to do harm to other computers. Because computers are coupled to the internet they are susceptible to be harmed by such codes that can, also, be launched from an intranet or even from the I/O terminals that are connected to the computers. Regardless of the source of the malicious code, there is a need to protect the computers.

System Services (also know as System Calls) are a bundle of software services that are usually provided in the Operating System of a computer. The System Calls or System Services relate to a set of instructions that perform a given function or action when invoke. They relieve the programmer from coding several lines of code that would be needed to perform the required function. The System Services or System Calls are a convenient and time saving feature of computer software, but they are also susceptible to harm by malicious code.

In a conventional computer system, most application programs run above the operating system in an area that is termed user space, and use these services to perform a given objective. The System Services are invoked when the application program issues a Call Request Message to the operating system. Most operating systems are provided with limited security to protect these System Services. The limited security may include checking the identification or privilege status of the requesting process or application program. It should be noted that application program, and process are used synonymously in this document. The persons (sometimes referred to as hackers) responsible for issuing malicious code are sophisticated, and can circumvent the current security system, and bring harm to the computers.

Another drawback with a conventional operating system is that the security checks in System Services are static in the sense that they are usually hard coded in the operating system, and require a new kernel whenever security checks need to be modified. Even in systems wherein changes, such as expanding the System Services, are permitted, the task of implementing such changes is very difficult. To effectuate such changes require shutting down the computer system, recompiling the operating system or part of it, and rebooting. This results in downtime that cannot be tolerated.

The need to expand System Services is even more important for Operating Systems that accommodate third party application programs. Some of these applications provide new functionalities, and commands which may also need new System Services to be functional. As a consequence, operating systems with fixed System Services routines are not suitable for use in these environments.

### SUMMARY OF THE INVENTION

An embodiment of the invention provides a mechanism that restricts the invocation of selected System Services based on policies provided by an administrator. In order to achieve this objective, a data base including the System Services to be protected, and associated policies are generated, and stored in a memory. When an application invokes a System Service, the System Call Handler intercepts, and examines the credentials to determine the identity of the process or application program which invoked the System Service. The System Service which is invoked, and associated attributes are correlated with the data base. If a match is found, the requesting application is permitted to use the requested System Service. If a match is not found, use of the requested System Service is denied. Depending on the implementation of the security mechanism approval to use, and/or denial can be logged, and the administrator is notified of the event. In addition, a tool is provided to dynamically adjust the information (System Services and related policies) in the data base, and down load them, via a System Service Call, into the operating system. Preferably, the System Services, and related user defined Policies are arranged in a table format.

The above as well as additional features, and advantages of an embodiment of the present invention will be apparent to one having ordinary skill in the art in view of the drawings, specification, and claims set forth herein.

### BRIEF DESCRIPTION OF THE DRAWINGS

FIG. 1 depicts a block diagram of a data processing system and network in which embodiments of the invention may be implemented.

FIG. 2 depicts a graphical representation of the architecture for the present invention.

FIG. 3 depicts a flow chart of the security process or method according to teachings of an embodiment of the present invention.

FIG. 4 depicts a schematic of the functional components of the System Call Handler, and its relation to other components of the security mechanism.

FIG. 5 depicts a schematic of an embodiment of the invention including a Kernel, and Kernel Extension providing System Calls to an application,

FIG. 6 depicts a schematic of a tool interacting with the data base storage, and the operating system. The tool can adjust information in the data base, and downloads the modified information into the operating system.

FIG. 7a depicts a schematic of the functional modules of the tool.

FIG. 7b depicts a schematic of the functional modules that the System Call that is utilized by the tool to download policies from storage into the Kernel, and/or Kernel Extensions.

### DETAILED DESCRIPTION OF AN EMBODIMENT

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

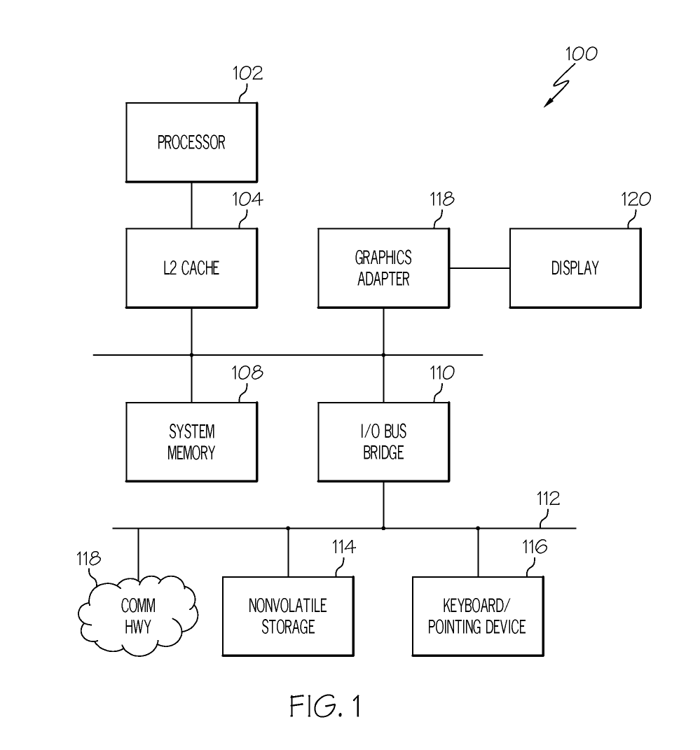

FIG. 1 shows data processing system 100 couples through I/O bus 112 to communications highway (COMM HWY) 118 which provides a communication path between the data processing system, and remote devices. The communication highway could be any of the well known transmission paths, such as the World Wide Web (hereafter internet), local area network or the like. The data processing system 100 includes system bus 106 to which a level two {L2) cache 104, system memory 108, I/O buss bridge 110, and graphics adapter 118 are operatively connected. The graphics adapter 118 outputs graphics on display 120 to which it is connected. I/O bus bridge 110 is also connected to I/O bus 112 which in turn is connected to non volatile storage 114 which may be a hard disk drive, and keyboard/pointing device 116 which may include a conventional mouse, track ball or the like. The I/O bus bridge 110 is provided with logic that controls the receipt, and transmission of data to, and from any of the devices on the I/O bus 114. The processor 102 is connected to the L2 cache, and has access to all devices on the system bus 106. The operating system, and System Services which are protected by the safety mechanism of an embodiment of the present invention are located in the memory space of the Processor. The operating system is, also termed, Kernel. As a consequence, both terms are used interchangeably within this document. The application program is positioned on top of the operating system in the memory space of the Processor.

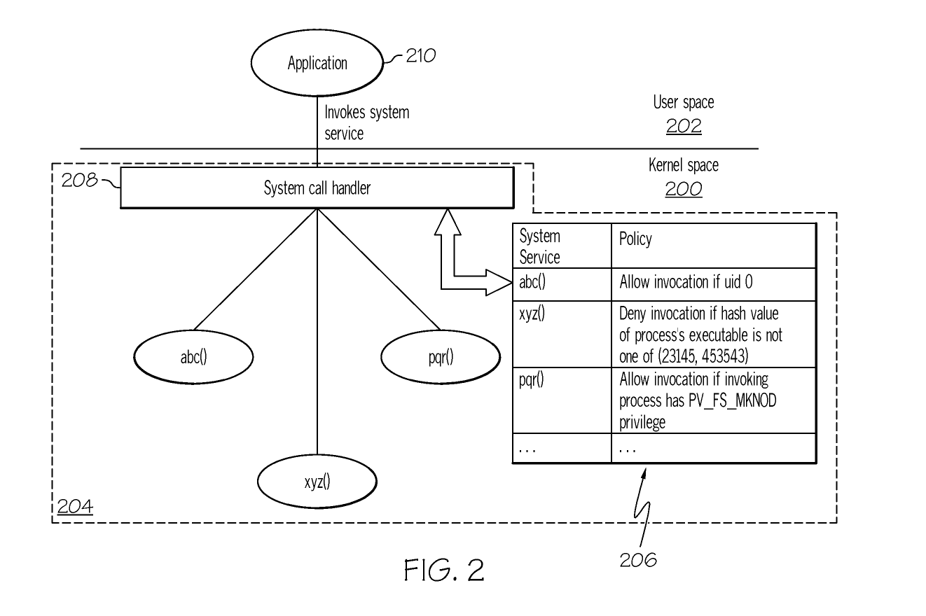

FIG. 2 shows a graphic representation of the architecture for an embodiment of the present invention. The space in memory that is occupied by the operating system is referred to as Kernel Space 200, whereas space occupied in memory by the application is termed User Space 202. These designation are exemplary. They are only used to discuss the invention, and should not be construed, in anyway, as a limitation on the scope of an embodiment on the scope of the invention. The Kernel Space 200 includes operating system 204, table 206, and a set of System Services abc( ) xyz( ) . . . and pqr( ). It should be noted the number of System Services embedded in the operating system is a matter of design choice, and the showing of three in FIG. 2 should not be construed as a limitation on the scope of an embodiment of the invention.

Still referring to FIG. 2, table 206 is partitioned into a System Service column, and a Policy column. The System Services to be protected are written in the System Service column, and associated or corresponding Policies that relate to the System Services are written in the Policy column. For example, System Service abc( )) is paired with Policy Allow invocation if uid 0. Similarly, System Service xyz( ) is paired with Deny invocation if hash value of process's executable is not one of (23145, 453543). Finally, System Service pqr( ) is paired with Policy Allow invocation if invoking process has PV_FS_MKNOD privilege. Each of the System Services set forth the Policy under which its use by a requestor, such as an application program, is allowed or denied based on whether or not attributes in the process credentials satisfy or meet the requirement of the policy. As a consequence, a request to use System Services abc( ) would be allowed if and only if uid (user identification) of the requester is 0. Similarly, a request to use System Service xyz( ) would be denied unless the hash value of the requester executable is one of 23145, 453543}, and so forth. Other policies that one may elect to adopt include: allow invocation if the invoking process has a certain privilege and deny invocation if the current time of day is between selective times, such as 10:00 pm and 5:00 am. Such a time restrictive policy would ensure invoking the related System Service only occurs during day time. It is evident from these examples that a user may placed any policy or condition he wishes to place on a particular System Service and a requester could not access that service unless the policy is fulfilled. It should be noted arranging the System Service, and corresponding policies in a table format is only one way of structuring the invention, and others skilled in the art could devise alternative arrangements. Any such alternative arrangements are deemed to be covered by the claims of the present invention.

In one embodiment of the present invention, the table carrying the System Services, and corresponding Policies are prepared, and stored on a disk, storage, such as nonvolatile storage 114 (FIG. 1), and download into Kernel Space 200. By doing so, an embodiment of the invention provides a designer the freedom of adjusting (adding, and/or deleting, and/or modifying) security polices for System Services without shutting down the system or adversely interfering with normal operation. As a consequence, the method of the present invention is dynamic and non intrusive.

Still referring to FIG. 2, Kernel Space 200 includes System call handler 208 which is the gateway into the operating system 204. As will be explained in greater details below any message, such as the one originating from application 210, to access a particular System Service is acted upon by the Processor under control of the logic in the System call handler. As a consequence, the message is intercepted, examined, correlate with table 206, and issue denied or allowed authorization based upon user selected policies of a user, and results of the correlation.

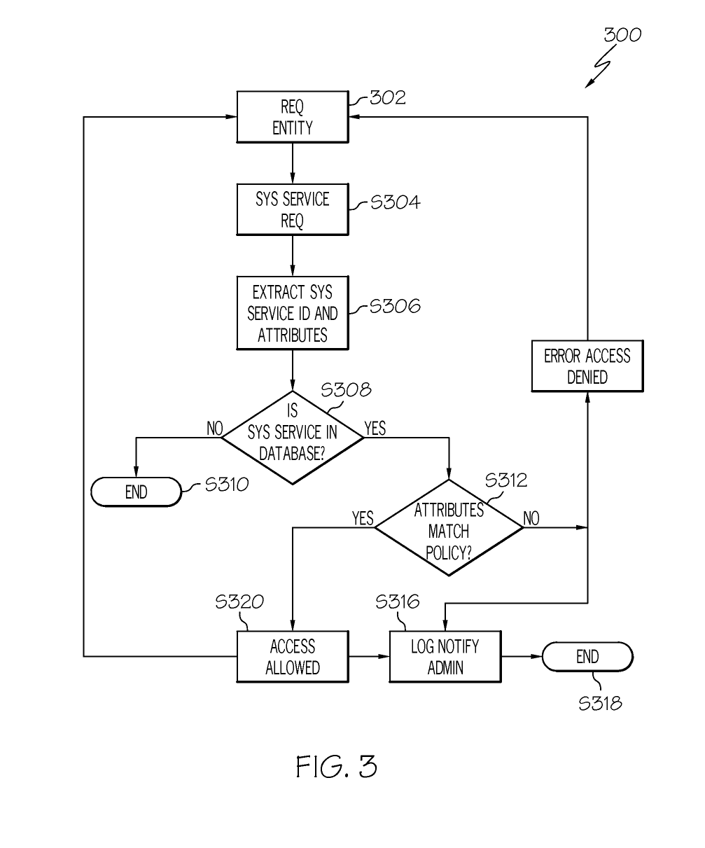

FIG. 3 shows the flow chart 300 of the method according to an embodiment of the present invention. The method begins in step S304 whereat entity 302, including an application program, issues a System Service Request (SYS SER REQ) to access a particular System Service. The method enters step S306 where the Processor under control of System Call Handler (details set forth below) 208 (FIG. 2) examines the request, and extracts System Service id, and attributes. A decision is then made at step S308 as to whether or not the requested System Service is in the database. The decision can be implemented by comparing the identity (id) of the requested System Service extracted from the request message with entries in the database. If no match is found, the process ends at step S310. In addition, normal processing of data could be allowed to proceed as if the invention was not deployed on this data processing system.

Still referring to FIG. 3, if System Services at step S308 is found in the data base, the method exit step S308 along YES path into step S312 whereat it is determined if the attributes extracted from the message requesting access to the System Service matches the policy set forth in the data base. The test for policy compliance can be achieved by a comparison routine. If the attributes do not match the Policy statement in the data base, the process exit step S312 along the NO path into step S314 whereat an error message denying access is generated and returned to the requesting entity 302. As an optional step, the error is logged and the administrator is notified at step S316. The process ends at step S318. If at step S312 the attributes extracted from the message requesting System Service matches policy statement in the data base, the process exit along the YES path into step S320 whereat access is allowed, and the requesting entity is notified accordingly. As an optional step the allowance is logged, and the administrator is notified at step S316. The process then ends at step S318.

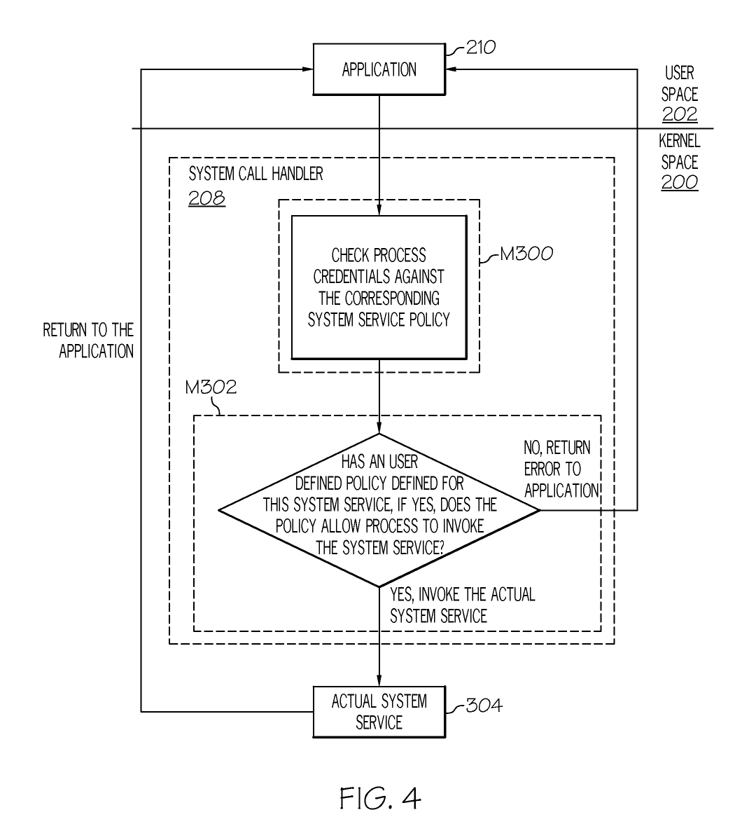

FIG. 4 depicts a high level functional block diagram of the System Call Handler, and its relation to other components, such as Application program in User space, and Actual System Service in the operating system, of the security mechanism. For simplicity, entities in FIG. 4 that are similar to previously described entities are marked with like numerals, and are not discussed further. The System Call Handler 208 includes module M300 that checks credentials in a request for System Service received from an Application program. Module M 302 determines if an user define policy is defined for this system service. If yes, does the policy allow the Application to invoke the System Service. If No, return an error to the application. If YES, return actual System Service 304 to the application.

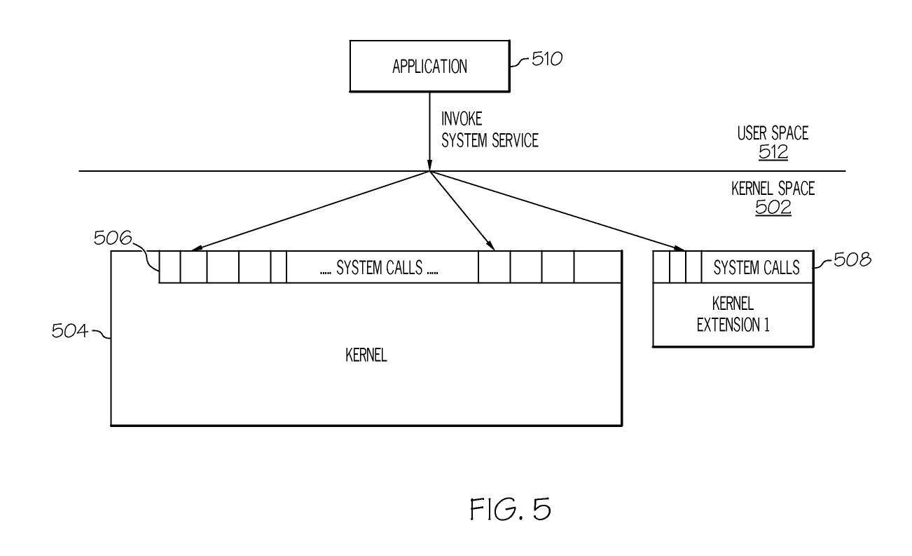

FIG. 5 shows a second embodiment according to teachings of the present invention. In this embodiment, Kernel space 502 includes Kernel 504 and Kernel Extension 1. It should be noted that additional Kernel Extensions can be added to Kernel space. Each of the Kernel Extensions has its own set of System Services (also known as System Calls) 506 and 508, respectively. The system may include one kernel which provides a set of System Services. The additional Kernel Extensions provide more System Services to the applications. It should be noted that System Services, and System Calls are used interchangeably within this document. By providing two kernels and two sets of System Services. an application, such as 510, running in User Space 512 can access both. When Application 510 invokes System Services the control is transferred to either Kernel 504 or Kernel Extension 1. The Kernel Extension 1, and associated System Services 508 could be added after the main Kernel 504 and System Services 506 are provided in a product. Being able to provide Kernel extension, after installation of the main kernel, gives a user the powerful advantage of utilizing functionalities of application programs available after the main kernel and associated System Services are made available. Often times, new functionalities may be provided by external third party software that are installed on a computer system after the main operating system, and associated System Services are installed. These applications may provide more System Services. Utilities, such as commands etc., may have been provided that make use of these services. As a consequence, an embodiment of the present invention provides dynamic flexible polices to secure System Services provided by both the kernel, and one or more Kernel Extensions. It should be noted that policies can be added for the Kernel Extensions.

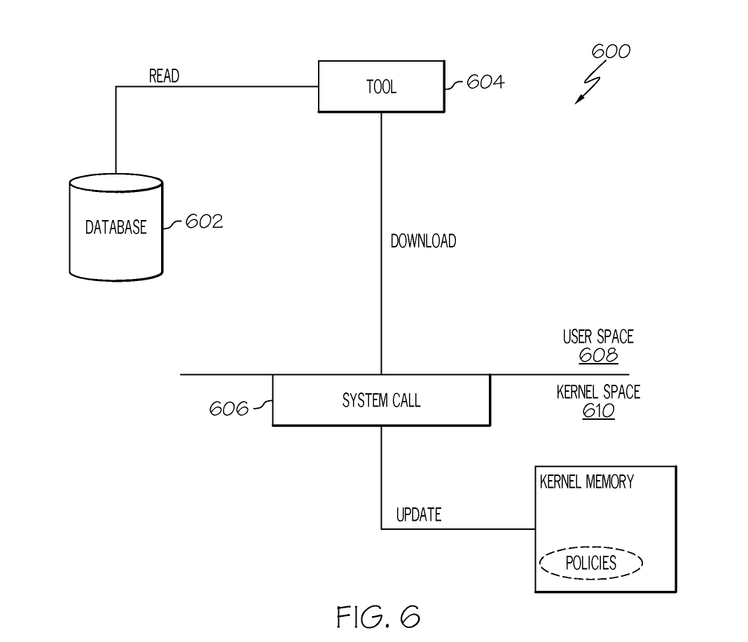

FIG. 6 depicts a graphical representation 600 that shows how an embodiment of this invention may be implemented on a computer system. The database including System Services to be protected, and Policies are generated, and stored on computer readable medium 602 which may be hard disk (internal) or other external storage. The tool 604 reads the database, and download the information into the Kernel using the System Call 606 which in tern updates information, including Policies etc., in the table located in the Kernel memory, and previously described. The tool 604, and computer readable medium 602 are in user space 602, whereas System call 606, and Kernel memory are in Kernel space 610.

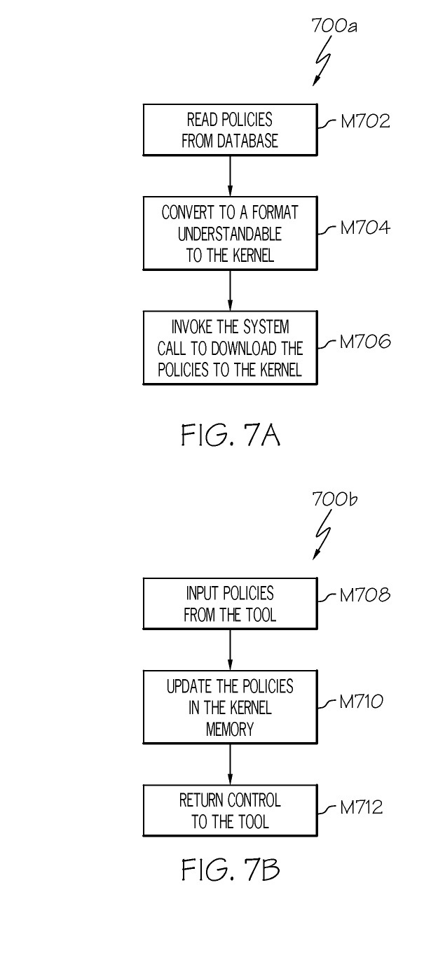

FIG. 7a depicts a graphical representation of functional modules of tool 700a which together with System Call 700b down load policies from storage into the Kernel, and/or Kernel Extensions. The tool 700a includes functional modules M702, M704, and M706. At module M702 the tool reads policies provided in the database. The tool, at module M 704, converts the policies into a format recognizable by the Kernel, and/or Kernel Extensions. The tool then invokes the System Call (FIG. 7b) to download the policies into the Kernel, and/or Kernel Extensions.

FIG. 7b shows a graphical representation of functional modules for System Call 700b which, upon invocation by tool 700a, downloads policies into the Kernel, and/or Kernel Extensions. System Call 700b includes modules M 708, M710, and M712. At module M708, System Call receives input policies from tool 700a. The kernel memory is updated with the received policies, at module M710. System Call then returns control to the tool (M712). This terminates the description of an embodiment of the invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method performed in a computer for protecting System Services, said method comprising:
receiving, in an operating system, a message, from an entity, to access one of said System Services;
examining said message to determine pre defined parameters;
correlating the pre defined parameters with a data base including at least one System Service entry, and at least one user defined policy associated with said at least one System Service entry; and
issuing to the entity a return message based on results of the correlation.

2. The method of claim 1 including logging in a memory information associated with the request, and the results of the correlation.

3. The method of claim 2 further including notifying an administrator if a return message dent's access to the requested System Service.

4. The method of claim 1 including generating the data base; and
storing the data base on a computer readable medium.

5. The method of claim 4 further including downloading the data base from the computer readable medium into the operating system.

6. The method of claim 1 wherein examination of said message includes extracting indicia that identifies the System Service for which access is requested; and
extracting attributes associated with the extracted indicia.

7. The method of claim 6 wherein correlation includes comparing the indicia extracted from said message with the at least one System Service entry; and
comparing the attributes with the at least one user defined policy only if a match is found between the indicia, and the at least one System Service entry.

8. The method of claim 7 wherein the return message that is issued includes a denial if the attribute does not match the user defined policy.

9. The method of claim 7 wherein the return message that is issued includes permission to use the requested System Service only if the attributes match the at least one user defined policy.

10. The method of claim 1 wherein the entity includes an application program.

11. Apparatus for protecting System Services in a computer comprising:
a first storage;
a data base stored in said first storage, said data base including at least one System Service entry, and at least one user defined policy associated with said at least one System Service entry;
a module operatively coupled to the data base, and performed in a processor, said module, and said processor intercepting messages requesting access to a System Service, examining said messages to determine pre defined parameters which are correlated with the data base, and issuing a return message allowing access to a requesting entity only if the pre defined parameters match said at least one System Service entry, and said associated user defined policy.

12. The apparatus of claim 11 wherein the first storage includes a kernel space within a memory of the computer.

13. The apparatus of claim 12 including a Kernel positioned within the kernel space;
a first set of System Calls associated with said kernel;
at least one Kernel Extension positioned within the kernel space; and
a second set of System Calls associated with said Kernel Extension.

14. The apparatus of claim 11 further including a second storage containing the data base; and
a tool for downloading said data base from the second storage into the first storage.

15. The apparatus of claim 11 wherein the at least one System Service entry, and the associated user defined policy are arranged in a table format within said data base.

16. The apparatus of claim 15 wherein the table contains at least two columns, one of the columns accommodating entries for System Services whereas the other column accommodates entries for user defined Policies.

17. The apparatus of claim 11 wherein the at least one user defined Policy relates to the pre defined parameters.

18. A program product for use in a computer comprising:
a computer readable medium;
a computer program embedded in said computer readable medium, said computer program including a first module with instructions for intercepting messages requesting access to a System Service, and instructions to check parameters from said message against System Services, and related user defined Polices; and
a second module with instructions to issue an error message denying access if the parameters do not match one of the System Services, and the related user defined Policy.

19. The program product of claim 18 wherein the second module further includes instructions to issue permission to access the requested System Service if the parameters match one of the System Services, and the related user defined Policy.

20. The method of claim 17 further including a third module having instructions to log the error, and instructions to notify an administrator.
